(19) United States
(12) Patent Application Publication
(10) Pub. No.: US 2016/0060124 A1
(43) Pub. Date: Mar. 3, 2016

(54) Coating of Graphene

(71) Applicant: Technische Universiteit Delft, Delft (NL)

(72) Inventors: Gregory Fabrice Schneider, Delft (NL); Cornelis Dekker, Delft (NL)

(21) Appl. No.: 14/931,552

(22) Filed: Nov. 3, 2015

Related U.S. Application Data
(63) Continuation of application No. PCT/NL2014/050291, filed on May 8, 2014.

(30) Foreign Application Priority Data
May 8, 2013 (NL) 2010776

(51) Int. Cl. C01B 31/04

(52) U.S. Cl. CPC C01B 31/0484; C01B 2204/02; C01B 2204/06

(57) ABSTRACT

A highly crystalline graphene and the coating of said graphene with a layer. Said graphene may have further structures, such as nanopores, nanogaps, and nanoribbons. The coated graphene can be used for biomolecular analysis and modification, such as DNA-sequencing, as a sensor, etc.

### CROSS-REFERENCE TO RELATED APPLICATIONS

This application is a continuation of International Application PCT/NL2014/050291, entitled “Coating of Graphene”, to Technische Universiteit Delft, filed on 12 Mar. 2014, which claims priority to Netherlands Patent Application with Serial No. 2010776, filed 8 May 2013, and the specifications and claims thereof are incorporated herein by reference.

### STATEMENT REGARING FEDERALLY SPONOSRED RESEARCH OR DEVELOPMENT

Not Applicable.

### INCORPORATION BY REFERENCE OF MATERIAL SUBMITTED ON A COM-PACT DISC

Not Applicable.

### COPYRIGHTED MATERIAL

Not Applicable.

### FIELD OF THE INVENTION (TECHNICAL FIELD)

The present invention is in the field of graphene and coating said graphene with a layer. Said graphene may have further structures, such as nanopores, nanogaps, and nanoribbons. The coated graphene can be used for biomolecular analysis and modification, such as DNA-sequencing, as a sensor, etc. The invention therefor also relates to use of coated graphene.

### DESCRIPTION OF RELATED ART

Graphene is carbon comprising material. Its structure relates to one-atom-thick planar sheets of sp2-bonded carbon atoms that are crystallographically densely packed in a honeycomb crystal lattice. The crystalline or “flake” form of graphite consists of many graphene sheets stacked together. It can be a basic building block for graphitic materials of all other dimensionalities. It can be wrapped up into fullerene, rolled into 1D carbon nanotubes or stacked into 3D graphite.

Graphene has attracted a lot of research interest because of its promising electronic applications related to its theoretical superior electron mobility, mechanical strength and thermal conductivity. It may have wide range of applications, for instance, field-effect transistors, photonic or optoelectronic device, as a gas or liquid membrane, sequencing DNA through nanoholes in graphene etc. Graphene macroscopic samples have unusual properties such as a bipolar-transistor effect, ballistic transport of charges, large quantum oscillations, etc.

Most of these applications demand modification of a graphene sheet into specific nano-patterns. In general production methods of graphene do not provide a monolayer thereof; at the best islands of a monolayer are obtained.

Nanopores are heavily studied for single-molecule screening and DNA sequencing. Because graphene may be in the form of layers of only one atom thin and may have excellent electrical properties, it is regarded as a potential successor to biological and silicon-based nanopores.

For nanopore-based DNA single-molecule analysis and sequencing a nanopore, a tiny hole in a membrane, can in principle be used as a nanoscale recorder that scans a DNA molecule from head to tail to ultimately read off the genetic information, for example using the ion current passing through the pore to probe the identity of the base. In the last decade, many groups have developed strategies to detect DNA molecules using nanopores to understand the biophysics of DNA translocation. Only very recently, it was demonstrated that biological nanopores can be used to obtain sequence information if a DNA polymerase is used to slowly ratchet the DNA through the pore. Recently, graphene nanopores were introduced. In principle crystalline graphene forms an ultimate nanopore membrane since it would be a hexagonal carbon sheet with a thickness of only a single atom, yet it is fully preventing ion transport across the membrane. Furthermore, it is electrically conductive, which opens up new modalities of directly probing the chemical nature of the bases, for example by running a tunneling current through the DNA molecule that is traversing a graphene gap.

A problem with nanostructures such as nanopores is, especially when analyzing biomolecules such as DNA, that pores tend to clog and biomolecules may stick either to membranes or in pores. As a result an analysis is at best incomplete and more likely impossible. A further problem with nanopores and the like is that dimensions thereof are poorly defined. Further also at an edge thereof the graphene is no longer a monolayer, but typically a multilayer (5-10 layers), e.g. due to processing. The edges themselves also are irregular, for instance not crystalline any more. As a consequence no reliable results, e.g. in terms of conductance, electrical current, etc. can be obtained. The effect of the above is that the nanostructures made are worthless.

Various patent documents and scientific documents recite coating of nanotubes, such as with enzymes. It is a purpose of the coating to functionalize the nanotubes. As a consequence characteristics of the nanotubes themselves changes.

Various patent documents and scientific documents recite coating of graphene oxide, which oxide is of a different nature. An objective may be to provide dispersions of graphene (oxide) in polar solvents. It is noted that one of the characteristics of an oxide is that it is not conducting or at the most semi-conducting (electrically). An example of such a document is an article by Weili Wei et al., in Chem. Sci., 2011, 2, pp 2050-2056, “Chiral detection using reusable fluorescent amylose-functionalized graphene”. Despite the title effectively graphene-oxide was functionalized, which graphene oxide was in a later stage reduced to graphene, which reduced graphene still comprises oxygen residues. The “graphene” obtained can not be considered as graphene, as it is unclear what its precise composition is. It also is unsuited for many applications as it contains too many defects, due to oxidation of graphene, reduction thereof, and presence of impurities as oxygen. A similar approach is taken by Teng et al., in Carbon 49 (2011), pp. 5107-5116, “Thermal conductivity and structure of non-covalenet functionalized graphene/epoxy composites”, wherein after oxidation of graphene to graphene oxide, the oxide is reduced to graphene, and thereafter functionalized with rather large polymeric molecules, in order to obtain (thermally) conductive layers. In a somewhat different approach Liu et al., in Langmuir, 2010, 26(12), pp. 10068-10075, “Synthesis, characterization, and multilayer assembly of pH sensitive graphene-polymer nanocomposites” a complex multilayer composite was formed. From the same author graphene nanocomposites in line with the previous article were formed (Liu et al., J. Pol. Sci., Part A, Pol. Chem. Vol. 48 (2010), pp. 426-433).

Various documents focus on self-assembled layers, specifically on metallic surfaces. Typically organosilane functionalization is used, which is in principle a method that is only applicable with reduced graphene oxide where graphene defects allow bond formation with the silane.

Various documents recite interaction of a coating (molecule) which relies on presence of defects in a structure of a surface to be coated. As a consequence characteristics of the structure are altered, typically adversely.

In an example of coating an article by Mann et al., in Angewandte Chemie Int. Ed., Vol. 52, nr. 11, 2013, pp. 3177-3180 a graphene layer is covered with tripods. Such coverage is not uniform over a surface, and it forms a relative thick layer. Due to the complex chemistry involved the thickness of the layer is not constant over the layer and the functionality may vary as well. In a similar approach from the same author functionalization of graphene is described (Mann et al., in JACS, 2011, 133, pp. 17614-17617, “Multivalent binding motifs for the noncovalent functionalization of Graphene”.

The present invention therefore relates to a graphene layer and coating said graphene with a layer, which overcomes one or more of the above disadvantages, without jeopardizing functionality and advantages.

### BRIEF SUMMARY OF THE INVENTION

The present invention relates in a first aspect to a method according to claim 1, in a second aspect to a graphene layer comprising at least one mono-layer of molecules, in a third aspect to a device comprising said graphene layer, in a fourth aspect to use of said graphene layer comprising at least one mono-layer of molecules, in a fifth aspect to a graphene layer comprising a mono-layer of molecules, and in a sixth aspect to a method of translocating single strand DNA using said graphene layer.

For an example of the present application, it has been found crucial to understand and block strong interactions between DNA and graphene. Inventors here demonstrate a novel scheme to prevent DNA-graphene interactions, based on a tailored self-assembled monolayer. For bare graphene, inventors have identified a remarkable phenomenon: it has been found that the better the crystallographic quality, the stronger DNA clogging of the pore is induced. Inventors developed a general strategy to tailor (or also sometimes referred to functionalize) an in principle hydrophobic surface of e.g. graphene nanopores by designing a dedicated self-assembled monolayer of molecules, such as pyrene ethylene glycol, rendering its surface hydrophilic. Inventors demonstrate that this tailoring of the surface of graphene with a mono layer, which mono layer conceals the graphene surface, prevents DNA from clogging graphene nanopores and show that single-stranded DNA can now be detected and analyzed while at the same time maintaining excellent nanopore durability and reproducibility.

It has been identified that to pursue the present approach in some aspects thereof, it is important to maintain the crystallinity of graphene right up to (and preferably including) the edges of a nanostructure such as a nanopore and the like, that is “defect free” graphene. (it is noted that graphene oxide, as well as reduced graphene oxide [graphene] both include many defects and the reduced graphene oxide also includes impurities, such as oxide/oxygen; hence such reduced graphene oxide is not considered to fall under the scope of the invention in view of the too high defect density). The edges themselves may be considered as irregular structures, in that by absence of carbon full crystallinity is lost. The present invention relates to nanostructures that, apart from a (one carbon atom) wide edge (region), the crystallinity of the graphene is largely without defects. The present invention in particular relates to nanostructures that are crystalline in an area of 0.3-10 nm from the edge. As such well-defined, highly crystalline, monolayers of graphene are provided, having no hilly structures (e.g. multi layers) near and/or at the edge. As a consequence the present graphene is fully covered up to the edge of a nanostructure with the present monolayer. In fact, future graphene devices—those for instance involving nanogaps or nanoribbons—were theoretically predicted to have sequencing capabilities if, and only if, graphene remains unaltered electrically and this is realized by conserving its crystallinity up to the edges. Also the covalent structure of graphene needs to be intact; such limits the use of (mono)layers significantly. It is noted that the edge is considered to be a critical part in such devices, e.g. in terms of crystallinity. If the nanostructures are not provided in a controllable, reproducible and reliable manner, a device will have varying and not very predictable characteristics, which is undesired in many instances. Such devices could to some extent function, but would have to be calibrated individually. Present inventors identified that DNA translocation of single-stranded and double-stranded DNA is in fact much more difficult when graphene nanopores are clean and crystalline, due to severe clogging and sticking of DNA. A general approach is developed to modify characteristics of graphene with (indirect) binding of tailoring groups. Especially binding is targeted, rather than a direct functionalization of graphene, in order to prevent irreversible electrical damage to the graphene. First of all a monolayer on graphene with present first molecules is formed, and then the first molecules are reacted with second molecules, the second molecules optionally tailoring the monolayer. As mentioned, the graphene remains unaltered. As such the graphene can be functionalized, or likewise tailored, with respect to e.g. a solvent, such as an aqueous solvent, an oily solvent, an organic solvent, and with respect to molecules present in such a solvent, such as biomolecules, and with respect to a further optional layer, such as e.g. in a semiconductor, in a membrane, etc. Especially the hydrophobicity/hydrophilicity of the graphene may be changed, e.g. in view of an intended use. The tailored graphene is therefore suited for many applications.

In prior art construction of graphene nanopores, pores were fabricated at room temperature by locally bombarding a monolayer locally with a 300 keV electron beam, as is shown in FIG. 1A. However these conditions yield the deterioration of the graphene lattice with increasing beam exposure time (as evidenced by the loss of the characteristic hexagonal diffraction pattern of graphene; FIG. 1A, situations 1-3). Present inventors have overcome this problem by exposing graphene at temperatures above 500° C. in a STEM mode of a TEM. As such it is now possible to preserve the graphene lattice neighboring e.g. a nanopore (FIG. 1B). In the case of pure graphene (including graphene nanostructures) obtained from the above methodology, no (or virtually no) defects are present.

Inventors fabricated graphene nanopores using the above approach, in an example with diameters from 3 to 20 nm, which were probed ionically in a buffer containing 1 M KCl and 10 mM Tris (pH 8.1). FIG. 1C plots the conductance values of these nanopores versus the pore diameter. As expected, the conductance of the nanopore increases for increasing pore diameter. The conductance can be modeled, e.g. by describing the total conductance G of a pore with diameter d in a buffer of conductivity σ as the inverse sum of the access resistance contribution and the resistance of a cylinder with a length L. A fit to the model shows that the present conductance values are distributed between L=0 nm and L=3 nm, with a best fit at L=1.2 nm; in other words close to a length for a monolayer of graphene. Such further evidences the fact that taking prior art data the structures disclosed therein relate to pores having a cylinder length of about 9 nm; that is the pores do not relate to monolayers of graphene, but typically to 5-10 layers, contrary to claims made. More precise, the pores relate to distorted graphene structures with a certain thickness, the thickness being a factor thicker than that of a monolayer graphene, whereas surrounding graphene could be one monolayer thick, e.g. visualized as a hilly structure around an opening. Such is also fully in line with observations of present inventors, in that highly crystalline and atomically flat nanopores and the like could not be made at e.g. room temperature. Surprisingly, if the crystalline nanopores reported in FIG. 1C are used to detect DNA molecules, severe clogging is experienced (FIG. 2A), as seen by the stepwise decrease in ionic current of the nanopore yielding irreversible pore closure. For a couple of seconds of incubation in the presence of DNA, a few translocation events are observed. Then, however, the pore gets clogged. The open pore current dropped to nearly zero, signifying a closed, irreversibly clogged, pore. Even short 1V pulses (FIG. 2A) were not sufficient to unclog the pore. Present inventors imaged this particular pore before and after clogging (FIG. 2B and 2C, respectively). After use, the DNA material is clearly visible on the STEM micrographs, as a white blob-like aggregate in the pore, along with the fibril-like structures around the pore.

Inventors hypothised that the clogging is due to DNA that sticks to the graphene. To investigate this, inventors studied single-stranded DNA on graphite with atomic force microscopy (AFM). When DNA is incubated on the surface of graphite (FIG. 2D) it is found to adsorb on the surface, as seen by the appearance of higher height patches on AFM images (FIG. 2E). Presumably, the interaction of DNA molecules relates to irreversible adsorption on the surface of graphene. To counteract these adsorption phenomena, it was proposed earlier that a very high salt concentration (namely buffers containing 3 M KCl) might hinder DNA (single-stranded and double-stranded) from adsorbing on graphene. This is however contradicted by the present observations with single-stranded DNA (FIG. 2D at 3 M KCl) and double-stranded DNA (at KCl concentrations of 1 M and 3 M, and various pH's ranging from 8.1 to 12; FIG. 2E). While such interactions are desirable in some sensor devices, they are preferably prevented in nanopore translocation where each nucleobase should slide through the nanopore (as opposed to stick irreversibly to the graphene surface).

To address the issue of clean crystalline graphene nanopores getting clogged in the presence of DNA, inventors designed a dedicated self-assembled monolayer. It is noted that often a monolayer will be provided at any freely accessible side of graphene, i.e. on one side or on two sides. Preferably the monolayer is orthogonal, that is that the present second molecule (or second group), or at least a part thereof, is directed away from the graphene surface, protruding in e.g. a solvent, preferably substantially in a same direction. In the present application the term orthogonal is to be understood as being under an angle with respect to the graphene surface, the angle being large enough for the part of the second molecule to protrude in a solvent, such as an angle of 30-90 degrees. In an example it is based on the combination of two chemicals, namely an aminopyrene molecule and a N-hydroxysuccinimide derivative of a 4-mer ethylene glycol molecule (FIG. 3A i) and ii) respectively). While the pyrene moiety will stick to the graphene, the ethylene glycol will stick out into a solution, and render the graphene surface hydrophilic. Note that, importantly, this self-assembled passivation scheme keeps the graphene material intact from chemical and electrical degradation that would otherwise easily result from (prior art) oxidation or covalent passivation methods. In an example the coating is applied in two consecutive steps from a 10 mg/mL solution of both molecules each in methanol. It has been found that solutions having a concentration of 0.1-10 mg/ml are preferred, even more preferred 1-10 mg/ml. If a higher concentration is chosen a shorter reaction/interaction time is sufficient, and vice versa. With a higher concentration a better coverage is obtained, and second molecules protrude somewhat more into e.g. a solvent. In a first step, interactions drive the adsorption of a monolayer of aminopyrene on graphene. In the example this is followed by the aminolysis of the N-hydroxysuccinimide ester on the carbonyl group (blue, FIG. 3Aii) by the primary amine on the pyrene molecule (red, FIG. 3Ai), forming a chemically stable peptide NHCO bond between the two molecules (FIG. 3A iii).

Inventors characterized DNA passivation properties of the self-assembled monolayer using AFM. Importantly, inventors found that DNA did not adsorb on graphite coated with the present self-assembled monolayer, even at concentrations of DNA as high as 10 ng/μL. This is evidenced by the similarities between the control AFM image (FIG. 3B, self-assembled monolayer on HOPG incubated with 10 mM Tris, 1 M KCl, 8 M urea, pH 8.1 for 10 minutes) and the same self-assembled monolayer incubated with the same buffer containing 10 ng/μL of single-stranded DNA (FIG. 3C). The self-assembled monolayer thus appears to act as an effective hydrophilic barrier that prevents the hydrophobic interaction between nucleobases in DNA and aromatic hexagons in graphene, by a dense packed thin monolayer of a reaction product of the present first and second molecules. The packing preferably covers the graphene surface by at least 20%, more preferably at least 50%, such as at least 80% and it may fully cover the graphene surface.

Most importantly, using this strategy, inventors were able to reproducibly translocate single-stranded DNA without pore clogging, with a total experiment time easily approaching hours, as evidenced by the stable conductance levels over the experimental time (FIG. 3D and inset). Such can not be achieved with the prior art methods, such as those mentioned above.

In order to estimate the added thickness of the self-assembled monolayer on the graphene, inventors probed a change in pore conductance upon applying the present coating for three pores with diameters of 5, 10, and 15 nm, respectively (FIG. 3E). Fitting the data inventors find that the length L of the assumed cylinder (self-assembled monolayer, graphene layer, self-assembled monolayer) increased from 1.5 nm to an apparent thickness L* of 5.5 nm upon forming the present self-assembled monolayer on the three nanopores mentioned above(FIG. 3E, blue curve). This suggests an added thickness of about 4 nm. Since the self-assembled monolayer in principle forms on both sides of the graphene membrane (on the top and bottom of the nanopore), the thickness per layer is about 2 nm. This value is in agreement with the expected head-to-tail length of the example Pyr-NHCO-EG4 molecule (0.4 nm for aminopyrene and 1.5 nm for the aminolyzed 4-mer ethylene glycol).

However, it is assumed that ethylene glycol chains are presumably also protruding into the nanopore area; hence the pore will effectively have a smaller diameter d*. Results of fitting are summarized in Table S1 and show a coating thickness and protrusion distance x of 0.7±0.1 nm. A similar value is obtained by fitting to the data presented in FIG. 3E (i.e., lowest reduced χ² for x=0.6±0.2 nm). A value of 0.6-0.7 nm is in good agreement with an estimated persistence length of ethylene glycol molecules in water (i.e., 0.3-0.5 nm).

The three coated pores studied above were used for translocation experiments with single-stranded DNA. In an example first the nanopore with a diameter of 10 nm was studied (FIG. 4). Single-stranded DNA can be driven electrophoretically through the present nanopore and detected by monitoring the ion current. Upon addition of the circular M13 single-stranded DNA molecule on one side of the pore and applying a voltage of 200 mV across the graphene membrane, a series of spikes is observed in the conductance traces (FIG. 4A). Each temporary drop in the measured conductance, ΔG, arises from a single DNA molecule that translocates through the pore. Two characteristic signals are observed, corresponding to two types of translocation events: type 1 events (where the circular molecule translocates in an non-folded conformation) and type 21 events (where the circular DNA molecule is in a folded conformation. Examples events are shown in FIG. 4B. From a large number (n=545) of such events, inventors obtain a histogram of conductance blockade levels ΔG, as presented in FIG. 4B. Three peaks are visible, the first being the open-pore current at 0 nS (i.e., the baseline); the peak at 3.8±0.5 nS which corresponds to one circular M13 molecule in the pore (i.e., two parallel single strands); and the peak at 7.5±0.6 nS due to two parts of same DNA molecule in the pore (i.e., four single stands). A scatter plot of ΔG versus the time duration of the events is shown in FIG. 4C. Each dot in this diagram represents a single M13 DNA translocation event. In addition to the event amplitude, inventors studied the translocation times of the events. The average translocation time is found to be 180±30 μs.

A similar analysis was carried for the two other nanopores (i.e., 5 and 15 nm), and conductance and dwell time histograms are shown in FIG. 5A and 5B respectively. As for the 10 nm pore, type 1 translocations are the most represented with conductance blockade amplitudes of ΔG₅ₙₘ=5.8±0.1 nS and ΔG₁₅ₙₘ=3.4±0.1 nS. The most probable translocation times in the distribution of the events are 250±50 μs and 135±20 μs for the 5 and 15 nm pore respectively. As represented in FIG. 5C, both these conductance blockade and dwell times increase when the diameter of the pores decreases, a trend that was also found for silicon-nitride pores. FIG. 5C does capture the trend in ΔG(d) qualitatively but quantitatively does not describe very well the values of the conductance blockade expected from the models developed for solid-state nanopores.

From present experiments, inventors conclude that if e.g. hydrophobicity of graphene is tailored with short hydrophilic ethylene glycol chains, then graphene nanopores can be used to reproducibly detect single DNA molecules without major sticking and clogging of the pore as it is observed when no self-assembled monolayer are used. Inventors identified a coating procedure using very short chains, such as 2-10 monomeric units, ideally 4, of e.g. ethylene glycol, to prevent any biomolecules from interacting with graphene (more specifically graphene nanopores). In an example it is preferred to have a relatively thin layer of graphene covered with the present monolayer. Inventors showed that pores are reproducible and stable and do not get clogged upon adsorption of double-stranded and single-stranded DNA, while the graphene remains unaltered chemically, which is a prerequisite to the design of future hydrophilic graphene nanopore, nanoribbon and nanogap devices. Inventors thus demonstrated a general approach to tailor the hydrophobicity of graphene.

Thereby the present invention provides a solution to one or more of the above mentioned problems.

Advantages of the present description are detailed throughout the description.

### DETAILED DESCRIPTION OF THE INVENTION

The present invention relates in a first aspect to a method of forming a modified graphene surface, according to claim 1, wherein the graphene is preferably highly crystalline. The method may be performed in one reactor.

In principle the first and second molecule may be reacted first forming a combined molecule, as an alternative, and then an aromatic part of the combined molecule may be interacted with the graphene surface. In other words, the present method may be performed in any sequence of steps identified.

In the present application, with terms as “molecule”, “group”, “moiety”, “solvent”, and examples given thereof, also substituted variants thereof are included, as well as mixtures thereof.

In the method a suitable solvent is provided, capable of dissolving the first molecules and graphene and preferably also the second molecules such that both present interaction and reaction can take place. It is noted that in an example the present method comprises two sequential steps; one for interaction of the first molecule with the graphene, and a second for reacting the first and second molecules, thereby forming a reaction product, such as by a condensation reaction, thereby forming a chemical bond. For interaction the first molecules have a binding group comprising at least one aromatic hydrocarbon group. The aromatic hydrocarbon group may comprise 4, 5, 6 or 7 atoms, preferably 5-6 atoms, more preferably 6 atoms. The aromatic carbon group may be a heterogroup, comprising one or more of N, O, S, preferably, however, the aromatic carbon group is a homogroup, comprising only carbons. It has been found that the at least one aromatic hydrocarbon group and the graphene have a sufficient strong interaction. Further, the first molecules have a chemically active first moiety, capable of reacting with a chemically active second moiety of second molecules, or vice versa. The reaction provides a strong chemical bond between the first and second molecule. In principle first the first and second molecule may react forming a reaction product, and then the reaction product may be interacted with the graphene; however, it has been found that in the latter case a good coverage of the graphene is difficult to achieve. It is noted that the first molecule and graphene interact; as a consequence especially the physical nature of graphene remains still sufficient to provide reliable results, e.g. when measuring conductance, applying an electrical current, etc.

In an example of the present method the aromatic hydrocarbon group has 1-20 aromatic groups, such as 2-10 aromatic groups, preferably being a poly aromatic hydrocarbon group, selected from naphthalene, phenanthrene, anthracene, tetracene, chrysene, triphenylene, pyrene, pentacene, corannulene, hexacene, coronene, benzo(a)pyrene, heptacene, octacene, ovalene, undecacene, decacene, and combinations thereof. It has been found experimentally that somewhat larger first molecules comprising at least a few aromatic groups provide a good interaction with graphene. It is noted that in principle also a mixture of first molecules may be provided. As such functionality can be tailored in more detail. It has been found that naphthalene, anthracene, and pyrene are very suitable binding groups, i.e. provide good interaction.

Further aromatic groups, such as nucleotides, amino acids, may also be used in the present method and graphene.

In an example of the present method the first moiety is selected from one or more of alcohols, carboxylic acids, ethers, esters, amino acids, amines, amides, and derivatives thereof, such as salts thereof. Amides, alcohols and carboxylic acids are preferred, e.g. because these molecules can be reacted in the present solvent without further measures. It is possible to make use of more than one moiety per first molecule, thereby forming “dimers”, oligomers”, etc. It is preferred to have 1-4 moieties per first molecule, and to form 1-4 bonds with the present second molecule.

In an example of the present method the second moiety is selected from one or more of alcohols, carboxylic acids, ethers, esters, amino acids, amines, amides, and derivatives thereof, such as salts thereof. Amides, alcohols and carboxylic acids are preferred, e.g. because these molecules can be reacted in the present solvent without further measures. It is possible to make use of more than one moiety per first molecule, thereby forming “dimers”, oligomers”, etc. Polymers are typically considered to be too large for the intended tailoring.

In an example of the present method the step d) reaction is a condensation reaction, preferably forming one or more of a peptide, an ester, and an ether. If required boundary conditions may be adjusted to achieve a desired result, such as temperature, pH, buffer, activator, time and catalyst. For the present method the boundary conditions as present are typically sufficient. As a consequence a chemical bond is provided that is suited for a specific purpose, e.g. being stable, relatively strong, applicable in a variety of environments and not interfering with intended use of the present graphene monolayer.

In an example of the present method the first molecule further comprises one or more of an alkane group, such as a cycloalkane group, and derivatives thereof, such as having 1-12 carbon atoms, preferably having 5-6 carbon atoms.

In an example of the present method the second molecule comprises a tail, the tail being selected from alcohols, such as mono-alcohols, alkanediols, alkanetriols, carboxylic acids, ethers, esters, amino acids, amines, amides, alkanes, alkenes, sugars, and combinations thereof, and derivatives thereof. In an example the tail is designed to prevent interaction of solutes and graphene. In an example the tail is designed to improve solubility of the graphene in the solvent. It is preferred to use relatively short second molecules, such as having less than 10 monomeric units. The second molecule may provide hydrophilicity.

In an example of the present method the solvent is an alcohol, such as a C₁-C₁₂-alcohol, such as methanol, ethanol, and propanol, preferably methanol. The solvent may be in its pure form, a mixture of alcohols, alcohol comprising water, etc. Methanol is preferred as it supports the intended reaction between first and second molecule sufficiently, and it provides good solubility towards graphene. Preferably a non-toxic (or slightly toxic) solvent is used.

In an example of the present method the second molecule has a length smaller than 20 nm, preferably smaller than 10 nm. For various applications a relatively short second molecules is preferred. It has been found that the length of the second molecule is important in order to maintain the present atomically thin electrode design, especially when uncontrolled variations in current or conductivity of graphene are best avoided. In some applications the second molecule preferably does not interfere with e.g. a molecule to be analyzed or sequenced. In an example the second molecule is smaller than 5 nm, such as 2 nm.

In a second aspect the present invention relates to a graphene comprising at least one mono-layer of molecules according to claim 7, preferably a highly crystalline graphene layer. The molecules comprise a binding group which comprises at least one aromatic hydrocarbon group, a second group, the second group being connected to the binding group. In an example the present mono layer has a thickness of less than 25 nm, preferably less than 10 nm, such as less than 5 nm, e.g. 1-2 nm.

In an example of the present graphene preferably at least two aromatic hydrocarbon groups are present in the molecules, as is indicated above.

In an example of the present graphene the second group is bounded to the binding group by one or more of an ester, an ether, and a peptide.

In an example of the present graphene the second group is selected from one or more of alcohols, such as mono-alcohols, alkanediols, alkanetriols, carboxylic acids, ethers, esters, amino acids, amines, amides, alkanes, alkenes, sugars, and derivatives thereof.

In principle the present graphene layer is obtainable by the above present method. Therefore, details of the present method in principle apply one to one to the present graphene.

In an example of the present graphene the aromatic hydrocarbon group has 1-20 aromatic groups, such as 2-10 aromatic groups, preferably selected from naphthalene, phenanthrene, anthracene, tetracene, chrysene, triphenylene, pyrene, pentacene, corannulene, hexacene, coronene, benzo(a)pyrene, heptacene, octacene, ovalene, undecacene, decacene, and combinations thereof.

In an example of the present graphene the graphene comprises a structure with at least one edge selected form one or more of a nanopore, a nanoribbon, a nanogap, preferably having a width of 3-20 nm. It has been found that for some application it is important to have a very precisely defined structure, in terms of shape, size, diameter etc. The better the definition of the structure the better results e.g. in terms of accuracy, reproducibility, analysis, etc. of a structure in use are obtained. For various applications the present structure is defined with an accuracy of 0.1 nm or better, which is in the order of one atom (C). The width of the present structure can be tailored to its intended use. For instance, a nanogap is envisaged for analyzing and for sequencing DNA, having a width of some 3 nm. Also characteristics of solvent, analytes, etc. may be taken into account when designing the present structure. The present graphene may have more than one structures. Also in this respect it is noted that various documents claim to provide similar structures; however using the prior art techniques mentioned in those documents such is effectively not possible.

In an example of the present graphene the edge of the structure is a monolayer and has a defect density of less than 1 defects/10 nm². A method for obtaining such a low defect density structure is described in Dutch Patent Application NL2008412. A method for obtaining a large single crystalline graphene is described in Dutch Patent Application NL2010216, both of the same applicant. The defect density is for some applications relatively important. As mentioned it has been found that for instance accuracy and reproducibility of conductivity and electrical current rely heavily on the crystallinity of the graphene used. The present graphene therefor preferably has a defect density of less than a few defects per unit area. It is noted that the present defect density is extremely low. Defects typically relate to impurities, distortion of crystal lattice, etc. As such also a method of forming nanostructures in combination with the present method is important, in order to keep a defect density as low as possible. Such is in particular important for sequencing of biomolecules. In order to obtain high speed of electrons (in the graphene) and ballistic transport the present example of coated highly crystalline graphene layer has found to be very suited.

In an example of the present graphene the graphene monolayer has a length of 1 mm-5 cm, whereas the width is 1 mm-2 cm. Such a graphene layer is large enough to handle, to process, and provides the present advantages.

Preferably the graphene layer comprises a number of nanostructures, such as an array of nanopores, such as an array of 1-10 by 1-100 nanopores (e.g. 10×10), allowing parallel measurements. For such structures the crystallinity of the graphene and the exact dimensions of the structure are even more important to provide reliable and reproducible results. A method for obtaining such an array is described in Dutch Patent Application NL2008412, of the same applicant.

In a further aspect the present invention relates to a device comprising the present graphene layer.

In a further aspect the present invention relates to a use of a graphene layer according to claim 12, preferably a highly crystalline graphene layer. Examples of such uses are given in the description and in the examples.

In a further aspect the present invention relates to graphene layer for use in one or more sequencing, analyzing, and sensing, especially of biomolecules, such as for DNA-sequencing, for RNA-sequencing, for analyzing biomolecules, and for reproducing biomolecules, preferably a highly crystalline graphene layer. It is noted that prior art graphene is of insufficient crystalline quality, especially close to edges of a nanostructure, to perform reliable, reproducible and controllable measurements. Further with the present quality fast recording is possible, contrary to prior art devices.

It is noted that some prior art devices may start with relatively crystalline graphene (relatively far away from an edge thereof), but upon applying a coating or the like inherently the crystallinity is destroyed.

In a further aspect the present invention relates to a functionalized graphene or graphene layer.

In a further aspect the present invention relates to a method of translocating single strand DNA using a graphene layer according to the invention, preferably a highly crystalline graphene layer.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### SUMMARY OF FIGURES

FIG. 1 A-C show crystalline nanopore in monolayer graphene and ion transport characteristics.

FIG. 2 A-E show DNA molecules clog crystalline graphene nanopores.

FIG. 3 A-E show Non-covalent functionalization of graphene with hydrophilic groups to prevent DNA from interacting with graphene.

FIG. 4 A-D show Translocation characteristics for a crystalline 10 nm graphene nanopore functionalized with a self-assembled monolayer.

FIG. 5 A-C show Translocation characteristics for 5, 10 and 15 nm coated graphene nanopores.

### DETAILED DESCRIPTION OF FIGURES

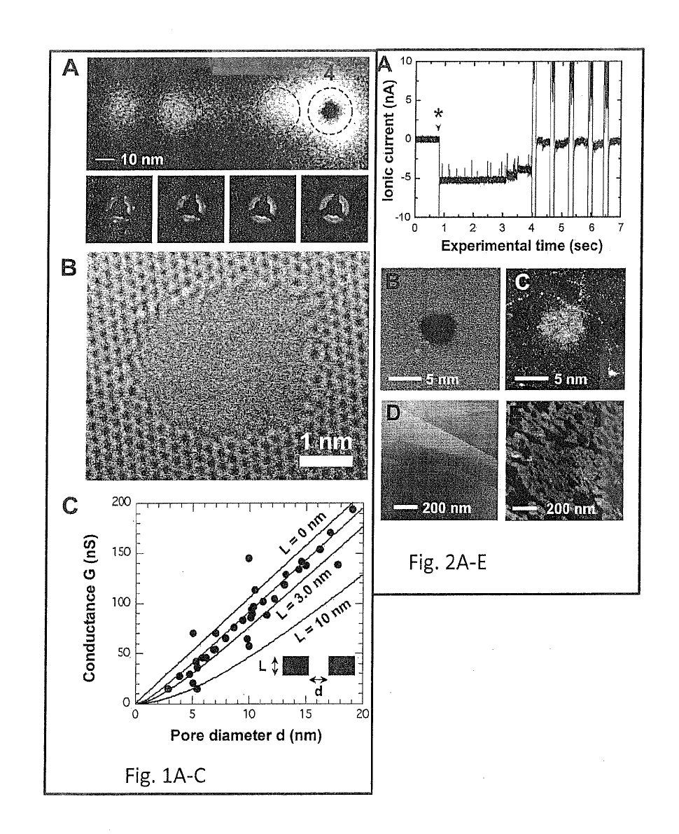

FIG. 1 shows a crystalline nanopore in monolayer graphene and ion transport characteristics. A) Contamination and amorphization induced by a focused electron beam on graphene at room temperature during nano-pore drilling in HREM mode. HREM nanopore drilling was carried at 300 kV, spot size 4 and C2 aperture 20 nm using an FEI Titan, equipped with Cs image corrector. Electron beam, focused into 10-nano size probe, was exposed in situations 1-4 on graphene with increased residual time, namely 10, 20, 30 and 40 seconds respectively. After the electron beam exposure nano-electron diffraction were taken and the results are shown in the bottom panel of 1A. B) 80 kV HREM image of a 3 nm pore with clean and crystalline edge drilled in STEM mode at 600° C. using an FEI Titan 60-300 PICO TEM equipped with a high brightness electron gun, an electron gun monochromator, a probe aberration corrector and a CS-CC achro-aplanat image corrector. C) Dependence of the conductance of crystalline nanopores on pore diameter. Black lines represent a model of conductance (see Eq. 1) and is plotted for L=0 nm, 3 nm, and 10 nm, where L represents the thickness of the nanopore membrane. The solid red line represent the best fit (lowest reduced χ²) for L=1.2 nm.

FIG. 2 shows DNA molecules clog crystalline graphene nanopores. A) Ionic current versus time of a 5 nm diameter graphene nanopore incubated with single stranded DNA M13 at a concentration of 2.5 ng/uL in 1 M KCl and 8 M urea. At time 0.7 s (*), the voltage is switched from 0 mV to 200 mV, resulting in a baseline current of -5.2 nA and upward peaks corresponding to DNA translocation events. After 2 seconds at 200 mV, the current baseline starts to decrease to zero in discrete steps, corresponding to a clogged pore. Large 1V pulses are subsequently applied across the nanopore in order to try to restore the stable current baseline, but this was unsuccessful. B-C) The 5 nm nanopore discussed in panel A before the translocation of DNA (B) and the same nanopore after the experiment that showed pore clogging (C), both imaged in the STEM mode of the TEM. D) Atomic force micrographs (AFM) of highly oriented pyrolytic graphite (HOPG) incubated 5 minutes with a solution of 3 M KCl and 8 M urea and rinsed with ultrapure water. E) HOPG incubated 5 minutes with single-stranded M13 DNA (10 ng/μL) in the same buffer.

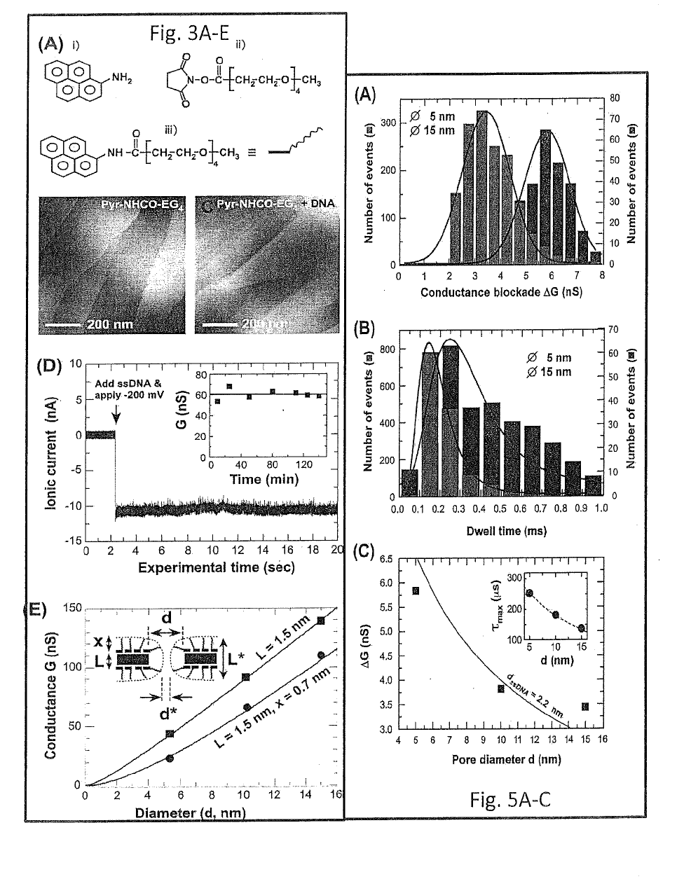

FIG. 3 shows non-covalent functionalization of graphene with hydrophilic groups to prevent DNA from interacting with graphene. A) Chemical structures of 1-aminopyrene (i), a N-hydroxysuccinimide ester derivative of a 4-mer ethylene glycol molecule (ii), and (iii) the product of the chemical reaction between i) and ii). B-C) HOPG coated with a self-assembled monolayer made of iii) and incubated with 1 M KCl and 8 M urea in absence (B), and after 10 minutes of subsequent incubation with the same buffer containing 10 ng/μL of single-stranded M13 (C). D) Representative raw trace of the ionic current versus time for a 14 nm diameter graphene nanopore coated with the SAM and incubated with single stranded DNA M13 at a concentration of 10 ng/μL in 1 M KCl and 8 M urea and plotted against the experimental time. The inset represents the variation in the conductance of the nanopore plotted against the experimental time. E) Conductance of three graphene pores with diameters respectively of 5, 10 and 15 nm before (red squares) and after applying the self-assembled monolayer consisting of molecule iii) (blue circles). The red solid line correspond to a fit of Eq. 1, yielding L=1.5 nm. The blue solid line is a fit of Eq. 2 for L=1.5 nm yielding x=0.7 nm.

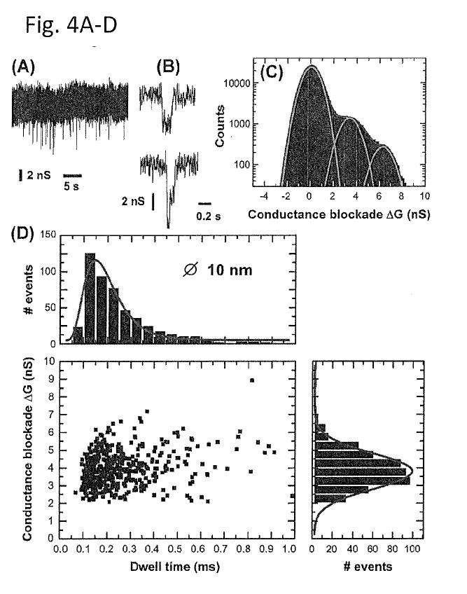

FIG. 4 shows translocation characteristics for a crystalline 10 nm graphene nanopore functionalized with a self-assembled monolayer. A) Translocation of circular M13 single stranded DNA across a 10 nm nanopore in a graphene monolayer. DNA molecules were dissolved in 10 mM Tris (pH 8.1), 1 M KCl and 8 M urea. B) Examples of translocation events of non-folded (type 1, top panel) and partially folded DNA (type 21, bottom panel) molecules recorded at 200 mV in this 10 nm pore. C) Conductance histogram collected from 545 translocation events, including the open-pore conductance before and after the event. D) Scatter diagram of the amplitude of the conductance blockade versus translocation time for DNA translocation through a 10 nm diameter nanopore in a graphene monolayer. The accompanying histograms for all the event types are included at the top and the right. Each point in this scatter diagram corresponds to a single translocation event. Applied voltage is 200 mV.

FIG. 5 shows translocation characteristics for 5, 10 and 15 nm coated graphene nanopores. A) Conductance blockade histograms. B) Dwell-time histograms obtained from analyzing the scatter diagrams for a 5 nm (gray) and 15 nm (black) graphene nanopore. C) Conductance blockades and dwell times (inset) versus pore diameter plotted for the three graphene nanopores. Black solid line represent the best fit of •G(d) at dssDNA=2.2±0.3 nm.

### EXAMPLES

The invention although described in detailed explanatory context may be best understood in conjunction with the accompanying examples and figures.

TABLE S1
Numerical solutions

| Diameter | G after | x | x |
|---|---|---|---|
| d (nm) | coating (nS) | (L = 0 nm) | (L = 1.5 nm) |
| 5.1 | 22.1 | 0.90 ± 0.01 | 0.70 ± 0.01 |
| 10.2 | 65.2 | 1.01 ± 0.01 | 0.76 ± 0.01 |
| 14.9 | 109 | 1.10 ± 0.02 | 0.82 ± 0.02 |

It should be appreciated that for commercial application it may be preferable to use one or more variations of the present system, which would similar be to the ones disclosed in the present application and are within the spirit of the invention.

What is claimed is:

1. A method of forming a modified graphene surface, the method comprising the steps of:
a) providing a graphene monolayer, having a defect density of less than 1 defects/10 nm²,
b) in a suitable solvent providing first molecules comprising a binding group,
b1) wherein the binding group comprises at least one aromatic hydrocarbon group, wherein the first molecules further comprise a chemically active first moiety,
c) adsorbing the first molecules on the graphene thereby forming at least one dense packed (mono) layer of the first molecules on the graphene surface, and
d) reacting the chemically active first moiety of the first molecules with a chemically active second moiety of second molecules thereby forming a reaction product having a chemical bond between the first and second moiety and a reaction product layer,
d1) wherein the aromatic hydrocarbon group has 1-20 aromatic groups,
wherein the first moiety is selected from one or more of alcohols, carboxylic acids, ethers, esters, amino acids, amines, amides, and derivatives thereof,
d2) wherein the second moiety of the second molecule is selected from one or more of alcohols, carboxylic acids, ethers, esters, amino acids, amines, amides, and derivatives thereof, and wherein the second molecule provides hydrophilicity, and
wherein in step d) reacting is a condensation reaction.

2. The method according to claim 1,
b1) wherein the first molecule further comprises one or more of an alkane group, and derivatives thereof,
wherein d2) the second molecule comprises a tail, the tail being selected from alcohols, carboxylic acids, ethers, esters, amino acids, amines, amides, alkanes, alkenes, sugars, and combinations thereof, and derivatives thereof.

3. The method according to claim 1, wherein the solvent is an alcohol.

4. The method according to claim 1, wherein the second molecule has a length smaller than 20 nm.

5. A graphene layer obtainable by a method according to claim 1, having a defect density of less than 1 defect/10 nm², comprising at least one dense packed mono-layer of molecules, the molecules comprising a binding group which comprises at least one aromatic hydrocarbon group, a second group, the second group being connected to the binding group, the second group being selected from one or more of alcohols, carboxylic acids, ethers, esters, amino acids, amines, amides, alkanes, alkenes, sugars, and derivatives thereof,
wherein the aromatic hydrocarbon group has 1-20 aromatic groups.

6. The graphene layer according to claim 5, wherein the graphene comprises a structure with at least one edge selected form one or more of a nanopore, a nanoribbon, a nanogap, wherein the graphene is highly crystalline, and wherein the edge of the structure is a monolayer and has a defect density of less than 1 defects/10 nm².

7. The graphene layer according to claim 6, wherein the graphene comprises an array of nanostructures.

8. A device comprising a graphene layer according to claim 5, wherein the device is selected from a NEMS, a MEMS, a circuit, a membrane, an energy storage device, electronics, a coating, an adhesive, a sensor, optics, photonics, a laser application, a touch screen, a nanochemical device, and combinations thereof.

9. Use of the graphene layer according to claim 5, in a use selected from the group consisting of biological application, a biomedical application, for molecular diagnosis, for analyzing samples, as a sensor, for osmosis, as a membrane, for specific adsorption, for biomolecular analysis, in a dispersion, as a lubricant, and combinations thereof.

10. The graphene layer according to claim 5 for use in one or more of the group consisting of sequencing, analyzing, and sensing, for analyzing biomolecules, and for reproducing biomolecules.

11. The graphene layer according to claim 5, functionalized with at least one mono-layer of molecules, the molecules comprising a binding group which comprises at least one aromatic hydrocarbon group, a second group, the second group being connected to the binding group, the second group being selected from one or more of alcohols, carboxylic acids, ethers, esters, amino acids, amines, amides, alkanes, alkenes, sugars, and derivatives thereof.
